(19) United States
(12) Patent Application Publication
(10) Pub. No.: US 2017/0208557 A1
(43) Pub. Date: Jul. 20, 2017

(54) DYNAMIC CHANNEL SELECTION FOR NEIGHBOR AWARE NETWORK (NAN) DATA LINK (NDL)

(71) Applicant: QUALCOMM Incorporated, San Diego, CA (US)

(72) Inventors: Abhishek Pramod PATIL, San Diego, CA (US); George CHERIAN, San Diego, CA (US); Santosh Paul ABRAHAM, San Diego, CA (US)

(21) Appl. No.: 15/404,912

(22) Filed: Jan. 12, 2017

Related U.S. Application Data
(60) Provisional application No. 62/279,364, filed on Jan. 15, 2016.

(51) Int. Cl. H04W 56/00; H04W 72/12; H04L 12/26; H04B 17/309; H04W 8/00

(52) U.S. Cl. CPC H04W 56/001; H04B 17/309; H04W 8/005; H04L 43/0882; H04W 72/121; H04W 84/12

(57) ABSTRACT

Aspects of the present disclosure provide techniques for dynamic channel selection for devices communicating via neighbor aware network (NAN) data link (NDL). As described herein, a NAN apparatus may evaluate a condition of one or more channels available for use by other devices of a cluster and the apparatus, select one of the one or more channels as an operating channel for the cluster and the apparatus based, at least in part, on the evaluated condition, and output an indication of the selected operating channel for transmission to the other devices in the cluster. The operating channel may be dynamically selected after determining a current operating channel has deteriorated, is unusable, and/or if performance of the current operating channel falls below a threshold. According to aspects, a channel hopping schedule may be used by devices communicating via the NDL to switch operating channels.

### CROSS-REFERENCE TO RELATED APPLICATIONS

This application claims benefit of priority from commonly-owned U.S. Provisional Application Ser. No. 62/279,364, filed Jan. 15, 2016, and entitled “DYNAMIC CHANNEL SELECTION FOR NEIGHBOR AWARE NETWORK (NAN) DATA LINK (NDL),” which is expressly incorporated herein by reference in its entirety.

### FIELD OF THE DISCLOSURE

Certain aspects of the present disclosure generally relate to wireless communications and, more particularly, to dynamically selecting an operating channel for a cluster of devices, for example, a cluster of devices in a neighbor aware network (NAN) which may communicate via a NAN data link (NDL).

### DESCRIPTION OF RELATED ART

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is the sub-1-GHz frequency range (e.g., operating in the 902-928 MHz range in the United States) being developed by the Institute of Electrical and Electronics Engineers (IEEE) 802.11ah task force. This development is driven by the desire to utilize a frequency range that has greater wireless range than wireless ranges associated with frequency ranges of other IEEE 802.11 technologies and potentially fewer issues associated with path losses due to obstructions.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure generally relate to wireless communications and, more particularly, dynamic operating channel selection for a cluster of devices in a NAN, including devices which communicate via an NDL and/or channel hopping in an NDL.

Aspects of the present disclosure provide an apparatus for wireless communications. The apparatus generally includes a processing system configured to evaluate a condition of one or more channels available for use by other devices of a cluster and the apparatus and select one of the one or more channels as an operating channel for the cluster and the apparatus based, at least in part, on the evaluated condition and a first interface configured to output an indication of the selected operating channel for transmission to the other devices of the cluster.

Aspects of the present disclosure provide an apparatus for wireless communications. The apparatus generally includes a processing system configured to switch from a current operating channel of a neighbor aware network (NAN) data link (NDL) to another operating channel of the NDL based on a channel hopping schedule and an interface configured to communicate on the other operating channel.

Aspects of the present disclosure provide a method for wireless communications by an apparatus. The method generally includes evaluating a condition of one or more channels available for use by other devices of a cluster and the apparatus, selecting one of the one or more channels as an operating channel for the cluster and the apparatus based, at least in part, on the evaluated condition, and outputting an indication of the selected operating channel to the other devices of the cluster.

Aspects of the present disclosure provide a method for wireless communications by an apparatus. The method generally includes switching from a current operating channel of a neighbor aware network (NAN) data link (NDL) to another operating channel of the NDL based on a channel hopping schedule and communicating on the other operating channel.

Aspects of the present disclosure provide an apparatus for wireless communications. The apparatus generally includes means for evaluating a condition of one or more channels available for use by other devices of a cluster and the apparatus, means for selecting one of the one or more channels as an operating channel for the cluster and the apparatus based, at least in part, on the evaluated condition, and means for outputting an indication of the selected operating channel for transmission to the other devices of the cluster.

Aspects of the present disclosure provide an apparatus for wireless communications. The apparatus generally includes means for switching from a current operating channel of a neighbor aware network (NAN) data link (NDL) to another operating channel of the NDL based on a channel hopping schedule and means for communicating on the other operating channel.

Aspects of the present disclosure provide computer readable medium having instructions stored thereon for causing an apparatus for wireless communications to evaluate a condition of one or more channels available for use by other devices of a cluster and the apparatus, select one of the one or more channels as an operating channel for the cluster and the apparatus based, at least in part, on the evaluated condition, and output an indication of the selected operating channel to the other devices of the cluster.

Aspects of the present disclosure provide a computer readable medium having instructions stored thereon for causing an apparatus for wireless communications to switch from a current operating channel of a neighbor aware network (NAN) data link (NDL) to another operating channel of the NDL based on a channel hopping schedule and communicate on the other operating channel.

Aspects of the present disclosure provide a station for wireless communications. The station generally includes a processing system configured to evaluate a condition of one or more channels available for use by other devices of a cluster and the station and select one of the one or more channels as an operating channel for the cluster and the station based, at least in part, on the evaluated condition, and a transmitter configured to output an indication of the selected operating channel to the other devices of the cluster.

Aspects of the present disclosure provide a station for wireless communications. The station generally includes a processing system configured to switch from a current operating channel of a neighbor aware network (NAN) data link (NDL) to another operating channel of the NDL based on a channel hopping schedule and a transceiver configured to communicate on the other operating channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates an example NAN cluster, in accordance with certain aspects of the present disclosure.

FIG. 5 illustrates an example NAN network with overlapping NAN clusters, in accordance with certain aspects of the present disclosure.

FIG. 6 illustrates an example NAN network with a plurality of NAN Data Link (NDL) clusters, in accordance with certain aspects of the present disclosure.

FIG. 7 illustrates an example NAN Management Frame (NMF) or Service Discovery Frame (SDF), in accordance with certain aspects of the present disclosure.

FIG. 8 illustrates an example AP Channel report element format, in accordance with certain aspects of the present disclosure.

FIG. 9 illustrates a block diagram of example operations for wireless communications by an apparatus, in accordance with certain aspects of the present disclosure.

FIG. 9A illustrates example means capable of performing the operations shown in FIG. 9.

FIG. 10 illustrates a block diagram of example operations for wireless communications by an apparatus, in accordance with certain aspects of the present disclosure.

FIG. 10A illustrates example means capable of performing the operations shown in FIG. 10.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to wireless communications and, more particularly, dynamic channel selection for a neighbor aware network (NAN) data link (NDL) group. As will be described in more detail herein, an NDL group (e.g., cluster) may include NAN devices (e.g., access points (AP) and/or non-AP devices in the NAN) that may wake-up in a synchronized manner to exchange data. Aspects described herein allow devices in a NAN to coordinate a channel scan and switch to another (e.g., better) operating channel in certain scenarios.

Furthermore, aspects described herein provide methods for NAN devices to distinguish between traffic which is associated with the NDL and traffic that is external to the NDL. By monitoring statistics gathered over time, one or more NAN devices may determine the occupancy of the current operating channel (e.g., how busy the current operating channel is). When the current operating channel is busy for over a threshold amount of time over a sample period, one or more NAN devices may proactively scan candidate channels in an effort to find a less-occupied channel on which to operate. The NAN devices may report, to a channel enforcer, information regarding potential operating channels based on the results of the proactive scans. The NAN devices may provide this report to the channel enforcer in response to a request from the channel enforcer.

As described herein, an owner, owner device, channel enforcer, scheduler and owner of a NAN may be used interchangeably. An NDL may have an owner or more than one owner.

Typically, the source of the traffic is the owner of the NDL. As an example, in the case of streaming music, the device that is the source of the music will be the provider and may be the owner of the NDL. In a many-to-many network, an NDL may have multiple enforcers. In a multi-user gaming scenario, many sources of traffic may exist. Any of the devices providing a source of traffic may assume the role of an enforcer. In some cases, a device may be designated as the owner based on a criteria. Example criteria may include, for example, how long a device has been in the NAN (e.g., age in the network), power status (e.g., if the device is plugged-in to a power source), and/or connectivity (e.g., how many other NDL devices are in a communication range of the device).

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA” such as an “AP STA” acting as an AP or a “non-AP STA”) or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communications System

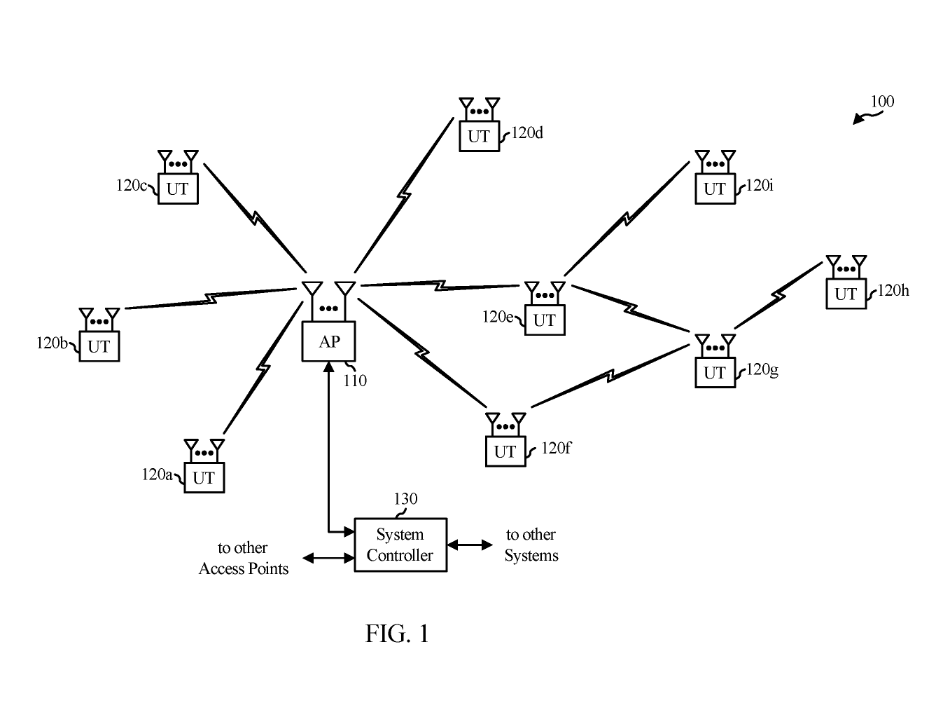

FIG. 1 illustrates a system 100 in which aspects of the disclosure may be performed. For example, any of the wireless stations (e.g., apparatuses, devices) including the access point 110 and/or the user terminals 120 may be in a neighbor aware network (NAN). The wireless apparatus may be configured to evaluate a condition of one or more channels available for use by other devices of a cluster and the apparatus and select one of the one or more channels as an operating channel for the cluster and the apparatus based, at least in part, on the evaluated condition. The apparatus may output an indication of the selected operating channel for transmission to the cluster.

According to aspects, the access point 110 and/or the user terminals 120 of an NDL may be configured to switch from a current operating channel to another operating channel based on a channel hopping schedule and communicate on the other operating channel.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

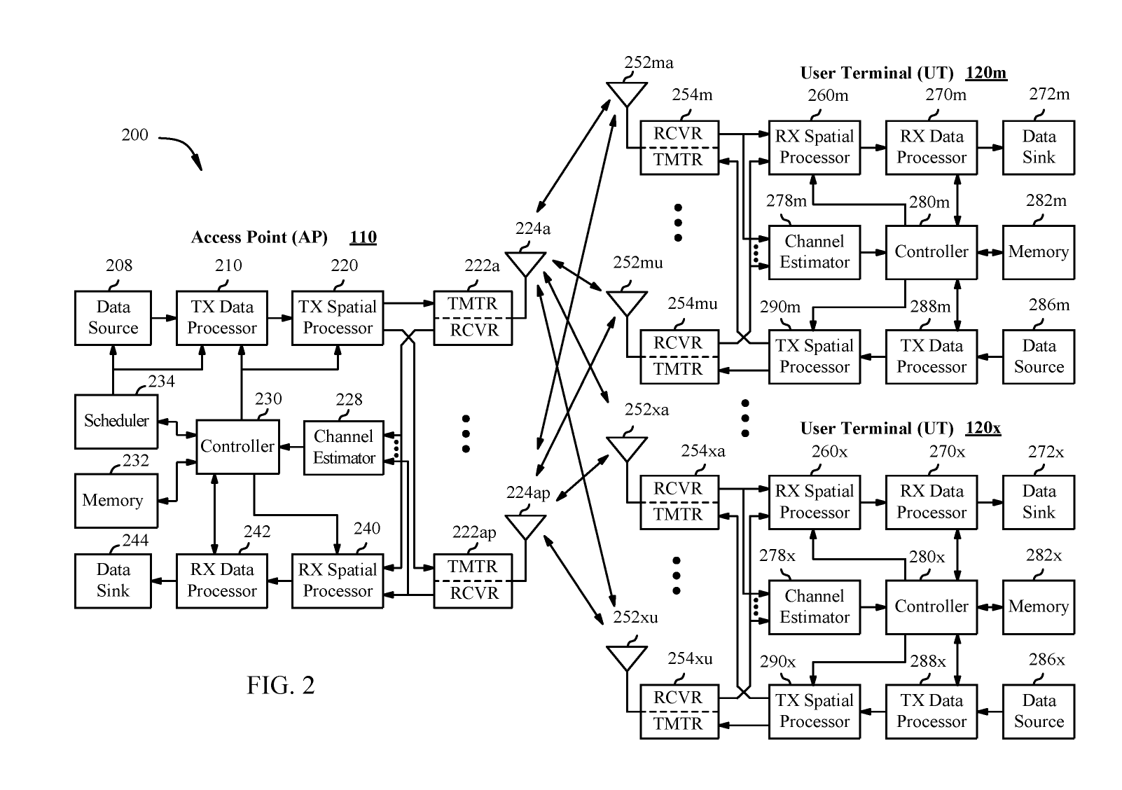

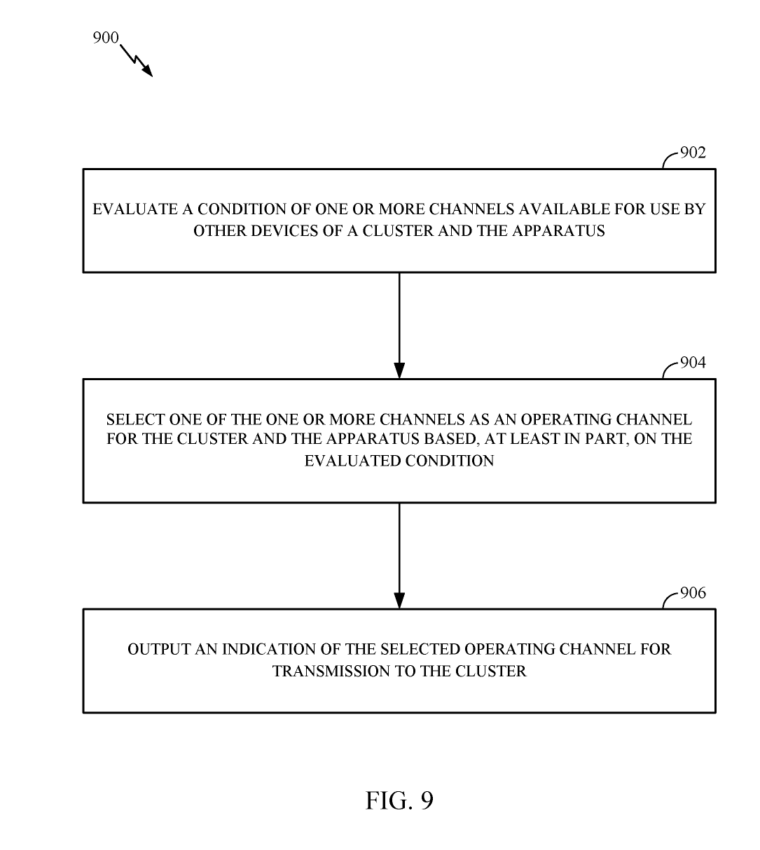

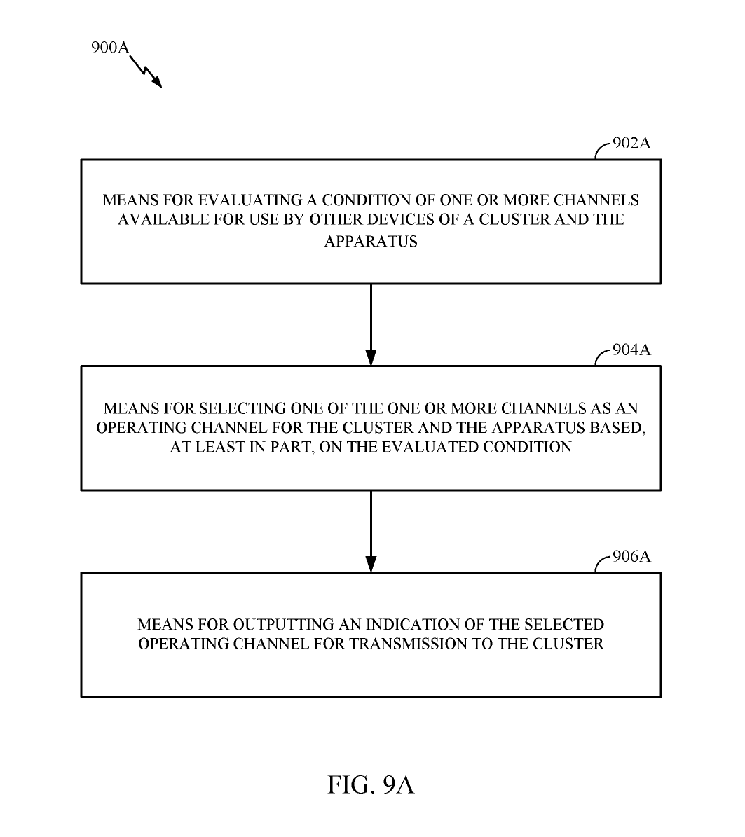

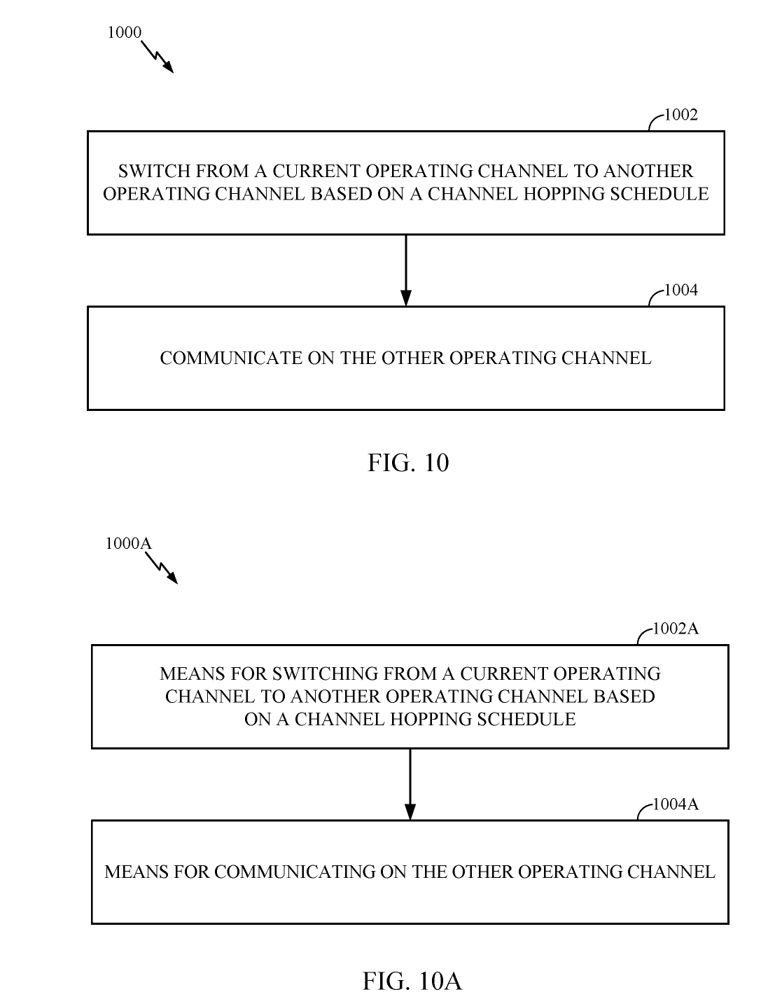

FIG. 2 illustrates example components of the AP 110 and UT 120 illustrated in FIG. 1, which may be used to implement aspects of the present disclosure. One or more components of the AP 110 and/or UT 120 may be used to practice aspects of the present disclosure. For example, antenna 224, Tx/Rx 222, processors 210, 220, 240, 242, and/or controller 230 or antenna 252, Tx/Rx 254, processors 260, 270, 288, and 290, and/or controller 280 may be used to perform the operations described herein and illustrated with reference to FIGS. 9 and 9A, 10, and 10A.

FIG. 2 illustrates a block diagram of access point 110 two user terminals 120m and 120x in a MIMO system 200. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut/m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

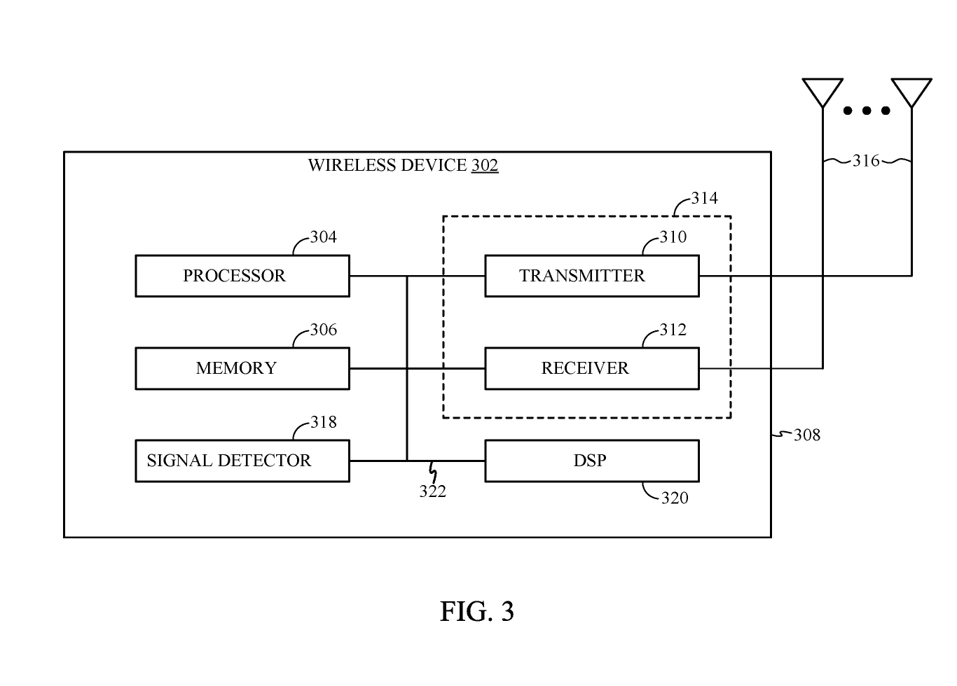

FIG. 3 illustrates various components that may be utilized in a wireless device 302 that may be employed within the MIMO system 100. The wireless device 302 is an example of a device that may be configured to implement the various methods described herein. For example, the wireless device may implement operations 900 and 1000 and illustrated in FIG. 9 and FIG. 10. The wireless device 302 may be an access point 110 or a user terminal 120.

While not illustrated, the wireless device 302 may include a first interface/module/system configured to perform NDL operations and a second interface/module/system for gathering information regarding, for example, potential operating channels for the NAN. According to aspects, the device 302 may use the second module for gathering information associated with potential operating channels while the first module is performing NDL operations. For example, the device may gather information regarding potential operating channels using the second module during time outside of the discovery window. In this manner, there may be no interruption to NDL operations since a first module may be used for channel scanning and a second, different module may be used for NDL communication.

Alternatively, the device 302 may leave the NDL and camp on one or more other channels in an effort to gather information. For example, the device 302 may have a single interface/module/system for both participating in the NDL and performing channel scanning. Accordingly, the single module may be unavailable for NDL operations when it is used for performing channel scanning operations.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

As described above, one or more modules may be configured to perform the operations and recited and described herein. For example, one or more of the Tx/Rx 222, 254, antenna 224, 252, controller 230, 280, channel estimator 228, 278, scheduler 234, and memory 232, 282 illustrated in FIG. 2 and/or the processor 304, memory 306, signal detector 318, transmitter 310, receiver 312, DSP 320 and/or antenna 316 illustrated in FIG. 3 may, alone or in combination, perform the means for evaluating, means for selecting, means for outputting, means for obtaining, means for scanning, means for determining, means for assigning, means for jointly processing, means for performing, means for registering, means for providing, means for switching, and means for communicating.

### Example Neighbor Aware Network (NAN)

Due to the increasing popularity of location-enabled (e.g., GPS-enabled) mobile devices, neighbor aware networks (NANs) are emerging. A NAN may refer to a network for communication between stations (STAs) that are located in close proximity to each other. NANs provide a mechanism for devices to synchronize the time and channel on which they converge to facilitate the discovery of service that have been made discoverable on existing devices or new devices that enter the environment.

A NAN discovery window (DW) may refer to the time and channel on which NAN devices converge. A collection of NAN devices (a WiFi capable device that supports NAN protocols) may include a NAN master (also known as a NAN channel enforcer, NAN channel selector, and/or NAN owner device) and a NAN non-master device. NAN master and non-master devices, which are synchronized to the same discovery window (DW) schedule, may be referred to as a NAN cluster.

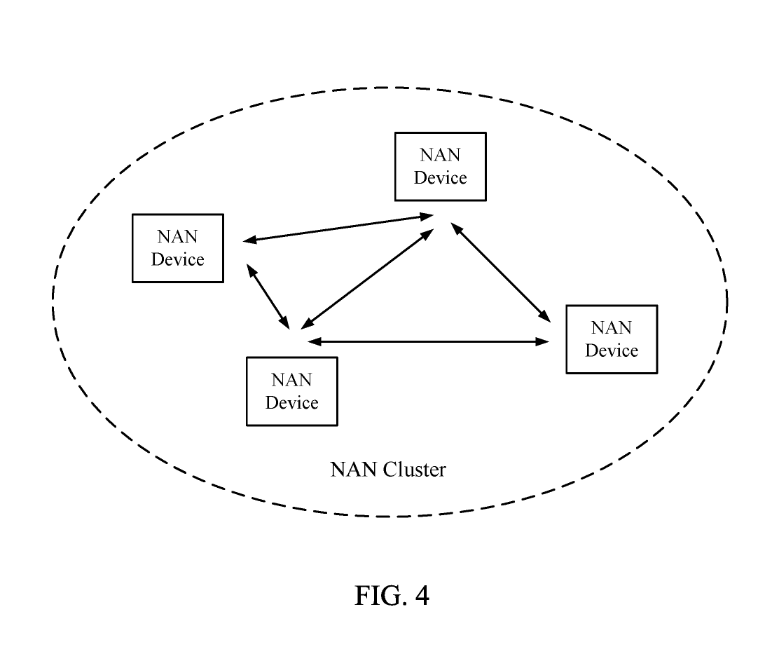

FIG. 4 illustrates an example NAN cluster, in accordance with certain aspects of the present disclosure. NAN devices (e.g., such as AP 110 or user terminal 120) that are part of a same NAN cluster may participate in a NAN Master Selection procedure. Depending on changes in the NAN cluster, different NAN devices may be selected to become NAN devices in a master role at different times.

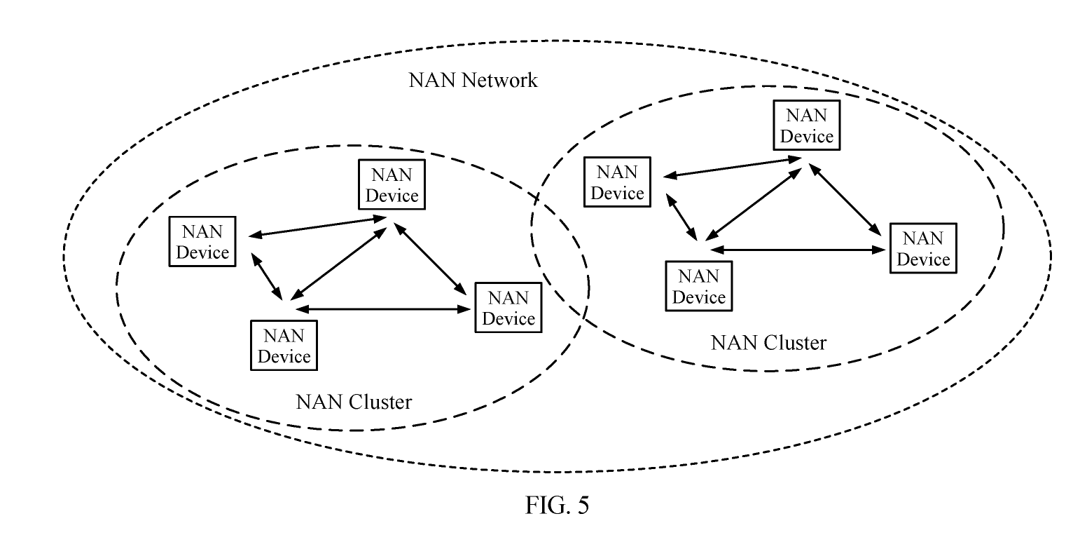

An NAN ID may be used to signify a set of NAN parameters. A NAN network may refer to a collection of NAN clusters that share the same NAN ID. FIG. 5 illustrates an example NAN network with overlapping NAN clusters, in accordance with certain aspects of the present disclosure. Although not shown in FIG. 5, a NAN device may participate in more than one overlapping cluster. Also not shown, a NAN device may operate concurrently in a NAN network with other types of WiFi networks (e.g., STAs in different homes or buildings as part of independent LANs with different external network connections) such as a wireless local area network (WLAN) or WiFi Direct.

During the discovery window (DW), the NAN devices are available with high probability for mutual discovery. During interim periods the devices may be asleep or involved with other activities, for example, communicating on other networks, possibly on a different channel. A NAN device that creates the NAN cluster defines a series of discovery window start times (DWSTs).

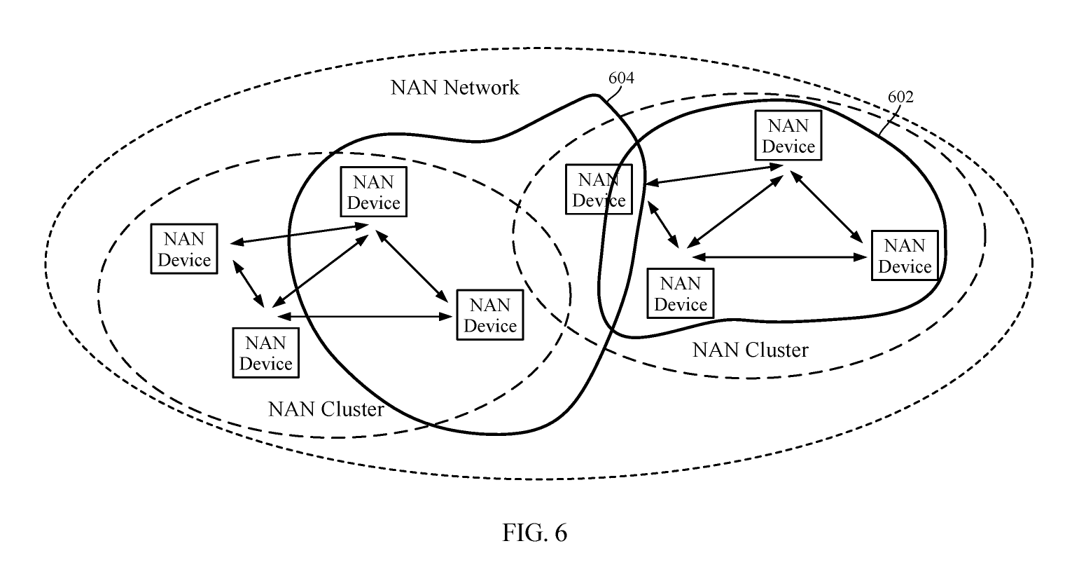

In some cases, as illustrated in FIG. 6, a NAN data link (NDL) cluster may be formed from a plurality of devices that are members of at least one NAN cluster. A wireless device in a NAN may provide a service to one or more other wireless devices in the NAN via an NDL. An NDL may comprise members of a single NAN cluster, as illustrated by NDL cluster 602, or members of multiple NAN clusters, as illustrated by NDL cluster 604. Members of an NDL cluster may perform data communications within the NDL cluster, but not necessarily with other members of the NAN with which the devices belong. Devices within a NDL cluster may perform communications within the NDL cluster outside of a NAN discovery window and not concurrently with transmissions within the NAN.

Accordingly, a subset of the devices in the NAN cluster may participate in an NDL. The devices that make up an NDL group may be a subset of a NAN cluster that shares a common transmission schedule. A transmission schedule may include a Paging Window (PW) and Transmit Window (TxW). Devices may advertise traffic (e.g., page other device in the NDL) during the PW and transmit buffered data during the TxW to devices that responded to the page. In some systems, the PW may not be included in the NDL schedule and the devices may transmit buffered data without any page announcement (e.g., assume that the peer device is awake and available to receive data). Devices in an NDL may share common security credentials which may restrict membership within the NDL group.

Devices in the NDL may be associated with a communication schedule. The communication schedule may indicate a timing and duration of PWs, data transmission windows, etc. of the NDL. Thus, to receive data associated with the service, a device participating in the NDL should occasionally monitor a communication channel associated with the NDL at a particular time, such as during a paging window, of the NDL. The NDL may be described as being built on top of the NAN network. The NAN network and the NDL may or may not operate on the same channel/frequency. According to one example, the NAN cluster may operate on a first channel (e.g., channel 6) while an NDL including devices of the NAN cluster, may operate on a second channel (e.g., channel 48).

### NDL Operating Channel

An NDL group (e.g., NDL cluster 602, 604) may include devices that wake-up in a synchronized manner to exchange data. Scheduled advertisements in an NDL may include information about an operating channel. An NDL schedule may consist of time-frequency blocks that span different channels.

Unlike other technologies, such as independent basic service set (IBSS), devices communicating via an NDL may switch to another channel by advertising a different operating channel. As described herein, devices communicating via the NDL may monitor performance (e.g., PER, a number of retries, etc.) regarding a current operating channel and, in response, may dynamically choose to switch to a different operating channel for NDL operation.

A cluster of devices communicating via an NDL, may not have single device that is considered the owner (e.g., master, channel-selector, channel enforcer, and/or NDL owner) of cluster. In fact, an owner may not be necessary for operations of an NAN or via an NDL. An owner may help coordinate, enforce, and/or arbitrate in an effort to ensure that NAN devices are synchronized (e.g., for channel scanning) and converge to a same channel for NDL operations. Accordingly, for purposes of dynamic channel selection, in certain scenarios, it may be advantageous to have a decision maker for dynamic channel switching and selection.

The details of determining the owner may be a topic for further discussion. According to aspects, the owner of the NDL may be may one of the devices communicating via the NDL. Additionally or alternatively, the owner may be a device communicating via the NDL with a highest master rank. If so, the devices may advertise their master rank in an effort to determine the owner. Additionally or alternatively, the owner may be a plugged-in device (e.g., connected to a power source). The status of being plugged-in may be captured by the master rank. Additionally or alternatively, a device with constant traffic may be selected as the owner. It may, however, be difficult to predict which device may have constant traffic. Additionally or alternatively, the owner may be a provider or source of a service, including for example, a scanning service, coupon service, and/or music service. A scanning service may be used to dynamically select a new operating channel for communications via the NDL. It may be advantageous for the provider or source of the service to have a clean channel, be a decision maker regarding selection of a new operating channel, enforce channel assessment, and move the NDL operations to the new channel. Additionally or alternatively, the owner may be selected or elected based on some criteria. For example, the owner may be selected based on location in an NDL topology. Regardless of the method of selection, the owner may be advertised in the NAN.

### Initial Channel Selection

When an NDL is first initiated, the owner may scan all channels to select a least busy channel as the operating channel. According to another option, the owner may randomly pick a channel and begin NDL operations. Scanning all channels to select a least busy channel may be slower than randomly picking a channel for NDL operations.

According to aspects, if no suitable operating channel is found, communication via the NDL may randomly hop from channel to channel. Hopping from channel to channel may be negotiated during NDL setup or, as described in more detail below, may be based on channel scan results. When communication via the NDL randomly hops from channel to channel, the NDL schedule may include a pseudo-random hopping sequence. The pseudo-random hopping sequence may be based, at least in part, on a random number and a time stamp, thereby incorporating channel diversity in every NDL schedule.

After initial channel selection, according to aspects, each device of the NDL may synchronously switch (e.g. hop) to a different operating channel based on an NDL schedule. An owner device may not be required for NDL devices to switch to a different operating channel based on an advertised NDL schedule. The hopping schedule may be negotiated during NDL setup or based on channel scan results. As described above, the hopping schedule may incorporate channel diversity.

When the NDL is first started, the load conditions on the selected operating channel may be unknown. In addition, the initial PHY rate, delay parameter, and overhead values may be estimates. Therefore, it is likely that the channel/time-block (TB)-schedule may not be the most optimal for the NDL. In order to quickly adapt and update, if needed, the sample interval, or time interval for which a provider gathers statistics on NDL performance, for the first instance may be reduced. For example, the sample interval for the first instance may be half of the sample interval for other instances.

### Dynamic Channel Selection for NDL

During NDL operations, and after initial operating channel section, the owner may periodically evaluate channel conditions of the current operating channel. The channel assessment may be based on one or more of performance of the current operating channel (e.g., PER and/or a retry count), sensed (e.g., measured) interference associated with the current operating channel (e.g., by a device), any factor used to evaluate a channel condition, and/or a combination these factors. According to aspects, sensing of the operating channel may include measuring interference on the operating channel due to co-channel and/or adjacent channels.

The owner may dynamically trigger a change in the operating channel when the operating channel becomes unusable (e.g., based on channel sensing/measuring and or any factor used to evaluate the channel condition) and/or when performance of the current operating channel drops below a threshold value. For example, a device may determine that the performance of the current operating channel is less than a threshold value based on NDL quality of service (QoS) requirements for the application of the service that is being supported by the NDL.

Upon establishment of a NAN, the QoS of the NDL may have been sufficient to meet data link requirements. Over time, however, throughput may have increased and/or the NAN may support more applications or more services. While the NAN may have been able to support the traffic needs upon establishment of the network, changing traffic conditions may trigger a change in the operating channel. Thus, the traffic the NAN is supporting and its corresponding QoS requirements, and not just the interference experienced by the operating channel, may trigger a scan of other potential operating channels, and a change in the operating channel.

Additionally or alternatively, a device communicating via an NDL (e.g., a non-owner device) may detect a poor current operating channel. The device may inform the owner of the poor channel. In some aspects, the device may request to switch to a different channel. The owner may obtain information regarding the poor operating channel from the device and may evaluate the condition of the operating channel based on the obtained information. Therefore, in certain aspects, the owner of the devices communicating via the NDL may be a coordinator and may not be the only device that performs a periodic evaluation of the channel conditions.

Once a decision is made to change the operating channel, the owner may gather usability information associated with other (potential operating) channels and may select another operating channel based, at least in part, on the obtained usability information. As described herein, channel usability and usability information may indicate if the channel can satisfy the QoS requirements for the application the NDL is supporting. The usability information may be obtained by scanning the other channels. The scan may be performed in an effort to find the least occupied channel. According to aspects, after a decision is made to change the current operating channel, the least occupied channel as determined by the usability information may be selected as a new operating channel for the NDL.

The owner, other devices communicating via the NDL, or a combination of both the owner and the other devices may perform one or more channel scans. According to aspects, devices in the NAN cluster which are not participating in the NDL may perform channel scans. These NAN devices may perform channel scans as a service and may report information related to channel occupancy to a device participating in the NDL. The channel scan by NAN devices not participating in the NDL may be used exclusively or in addition to the channel scan performed by devices participating in the NDL.

If the number of channels to scan is less than to a threshold value, the owner device may single-handedly scan all of the channels in an effort to find a suitable new operating channel. If the number of channels to scan is greater than or equal to a threshold value, the owner device may share the scanning responsibility with other devices in the NAN, which may include any combination of devices in the NAN not participating in the NDL or devices participating in the NDL. According to aspects, the owner may assign sets of the other channels to the other devices in communicating via the NDL for scanning in an effort to determine the usability information. In this manner, the owner may assign one or more channels to one or more devices that are part of the NAN cluster and/or communicating via the NDL.

Sharing the scanning responsibility, particularly when there is a large number of channels to scan, may help minimize an amount of time each device spends off of the operating channel. The owner may transmit, to each device, a request to scan channels as a data frame during an NDL-time block (NLD-TB) or as part of a service discovery frame (SFD) during a DW.

The owner may obtain usability information from other devices in the NAN (which, as described above, may or may not be participating in the NDL) and may jointly process the obtained usability information. Based, at least in part, on the joint processing, the owner may select an operating channel. As an example of joint processing, the owner may integrate results collected by other devices operating in the NAN. For illustrative purposes, a dwell time for a specific, potential operating channel may require scanning for 100 ms or more. A first device may scan the specific channel for 20 ms, a second device may scan the specific channel for 50 ms, and a third device may scan the specific channel for 40 ms. Each of the devices may report results of the scan and the start and stop time of their respective scan to the owner. Assuming each device scanned the specific channel at different times, the owner of the NDL may integrate the results of the scans obtained from the three devices in order to decide if the channel is a suitable operating channel.

According to aspects, a channel scan may be offered as a service by certain devices. For example, as described above, the channel scan may be offered by a device in the NAN cluster that is not participating in the NDL. The owner may register (e.g., subscribe) to such a channel scanning service or may provide the channel scanning service itself. The channel scanning service will be described in more detail below.

In an effort to assess a condition a current channel, a scanning device (which may be the owner of the NAN cluster or a NAN device) may hop to an assigned channel in an effort to determine how busy the assigned channel is. A NAN device performing this scan may report its finding to the owner. The report may be sent as a data frame to the owner during NDL-time block or as part of the service discovery frame (SDF) during a DW. According to aspects, the report may contain an indication of the best channel among the set of channels scanned by a particular device. The scan report may also contain metrics indicating channel conditions (e.g., current received signal strength indication (RSSI), adjacent RSSI and/or channel load conditions) of the scanned channels. Based on the received reports from one or more NAN devices, the owner device may make an informed decision regarding which channel to switch to.

After the owner has identified a suitable channel to move the NDL operation, it may inform NDL participants about the identified (e.g., selected) channel and an indication of a time period for when to switch to the selected operating channel. The time period for switching to the selected operating channel may correspond to a DW time. The owner may inform NDL participants of the selected operating channel via a broadcast message to the other devices in the cluster, a unicast message to each of the other devices in the cluster, or an advertisement message in a neighbor aware network (NAN) associated with the cluster of devices.

### Channel Scanning Service

Some devices may offer a service to scan various channels and provide information regarding how busy each channel is. The information may include details regarding whether or not a particular channel may meet the requirements of a particular service. In an effort to efficiently utilize resources, according to aspects, the information regarding various channels may be cached for future access if scan was recently performed.

The owner of the NAN may register and subscribe to a channel scanning service to obtain information used in determining a new operating channel. According to aspects, any scanning service, including known scanning services may be used to gather channel condition information. One or more devices in the NAN cluster which are not participating in the NDL may provide the scanning service.

In one example, the owner may provide the channel scanning service a list of channels to scan, as part of the owner's registration process with the channel scanning service. In another example, the owner device may not specify a list of channels to scan and may instead receive (e.g., obtain) usability information for the other channels.

Instead of registering and subscribing to a channel scanning service, the owner device may provide a channel scanning service itself. For example, a device that transitions into a NAN owner role may also become a channel scanning device. In this role, the owner device may scan channels in an effort to determine channel information for potential operating channels. According to another aspect, the owner device may transmit channel usage information for the potential operating channels in a beacon transmission and the owner device may be configured to obtain (e.g., receive) usability information regarding the potential operating channels from other devices in the NAN. The beacon may be a NAN beacon.

### Proactive Scanning

Devices in the NAN may distinguish between traffic which is associated with the NDL (intra-NDL traffic) and traffic that is external to the NDL (inter-NDL traffic). According to aspects, devices in the NAN may be able to identify broadcast traffic associated with the NDL. Further, devices in the NAN may use an NDL identification (ID), included in a frame that is transmitted to devices in the NDL, to determine if specific transmissions are occurring within the NDL or external to the NDL.

By monitoring statistics gathered over time, one or more NAN devices may determine the occupancy of the current operating channel (e.g., how busy the current operating channel is). When the current operating channel is occupied/busy for over a threshold amount of time over a sample period, one or more NAN devices may proactively scan candidate channels in an effort to find a less-occupied channel on which to operate. The NAN devices may report, to a channel enforcer, information regarding potential operating channels based on the results of the proactive scans. The NAN devices may provide this report to the channel enforcer in response to a request from the channel enforcer. The NAN devices may be participating in the NDL.

According to aspects, devices in the NAN may monitor channel conditions of the operating channel. For example, devices may filter packets in an effort to determine whether the packet belongs to the NDL or belongs to network outside of the NDL. Based on monitoring packets, a device may be able to determine how occupied the operating channel is. When the operating channel is occupied for over a first threshold amount of time (e.g., 40% of the time; busy for 40 ms over a 100 ms sample period), one or more devices in the NDL may enter a proactive scan mode.

According to aspects, devices in the NDL may enter a proactive scan mode when a time-block size (TB_{size}) increases beyond a threshold value. An NDL may be comprised of time-blocks which repeat in time. For example, each time-block may be 32 ms and may repeat every 128 ms. If the amount of traffic increases, 32 ms may not be enough to satisfy QoS requirements of the NDL. Accordingly, the TB_{size} may be increased from 32 ms to 48 ms, in an effort to meet QoS requirements. Additionally or alternatively, the amount of time between time-block repetitions may decrease from 128 ms to, for example, 96 ms or 80 ms, in an effort to meet QoS requirements.

Thus, devices in the NDL may proactively scan candidate channels when conditions (e.g., channel un-usability) regarding the current channel deteriorate beyond a certain threshold or when the TB_{size} increases beyond a certain value.

During proactive scanning, the device may first scan channels that were found to be less busy during previous scans. A device may randomize the scan order for channels for which historical data is not available (e.g., data has expired or channel was not previously scanned) or if the channel seems equally busy as the operating channel. In addition, a device may spend a cumulative dwell time on a candidate channel during the proactive scan prior to moving to a next candidate channel. According to on example, the device may spend 50 ms on a candidate channel before moving to the next candidate channel. A device may round-robin through the channel list once it has scanned each channel.

According to aspects, a device may hop to a candidate channel between time-blocks or during a portion of time-block in which the device is idle, having no incoming or outgoing traffic. For each channel, the device may compute and save the channel load and total scan time. The channel enforcer (scheduler device) may maintain a running average of channel load conditions for past sample periods. For example, the channel enforcer may maintain a running after for the past two sample intervals.

When the network is busy or occupied for more than the first threshold amount (e.g., percentage) of time, devices may search for a better operating channel via proactive scanning. Accordingly, a device, when available and not communicating via the NDL, may proactively search for a better operating channel. If the device is busy or occupied with NDL communication, it may not proactively scan.

When the operating channel is occupied for over a second threshold amount of time which is greater than the first threshold amount of time, the channel enforcer may determine NDL communication may benefit from switching from the current operating channel to another operating channel. According to one example, as noted above, the first threshold may be 40%. The second threshold may be, for example, 70% or 75%. Thus, when the operating channel is occupied for over 40% of the time, devices in the NAN may enter a proactive scan more. When the operating channel is occupied for 70% or 75% of the time, the channel enforcer may query one or more devices in the NAN to solicit information regarding other, potential operating channels for the NAN. Advantageously, upon receiving the query from the channel enforcer, devices in the NAN may have already scanned one or more other channels. The devices may report information regarding potential operating channels to the channel enforcer.

As an example, when the occupancy of the current operating channel exceeds the second threshold value, the channel enforcer may request feedback from devices in the NAN. If proactive scan results are available, the channel enforcer may compare scan results and select a least loaded channel to move the NDL operations. For example, the channel enforcer may receive feedback from, for example, five devices in the network. Three of the devices may report that Channel N is believed to be a good potential operating channel based on, for example, occupancy and QoS factors. Accordingly, the channel enforcer may decide to switch from the current operating channel to Channel N.

In this manner, the channel enforcer may receive feedback from one or more devices in network. Based on the feedback, the channel enforcer may determine that more than one, or several devices, report a specific channel with low occupancy. Accordingly, NDL operations may effectively switch operating channels based on the received feedback.

If proactive scan results are not available, the channel enforcer may itself shall scan a number channels, for example, three channels, in an effort to select the least loaded channel to move the NDL operation. As described above with respect to devices in the NDL, the scheduler may spend a cumulative dwell time on a candidate channel prior to moving on to a next channel during a scanning procedure. The dwell time may be, for example, 50 ms.

### Multiple Providers

In situations where an NDL has multiple providers (e.g., many-to-many service), each provider may run a scheduling algorithm independently and if necessary, advertise an updated schedule during the NAN-DW. Any provider may announce an update if it finds the current TB schedule or operating channel as unsuitable. Since all the providers are expected to be awake during the DW, each provider may see the other's service advertisement which may include a schedule/channel update.

In a situation where multiple providers advertise an update during the same DW, the first announcement may take precedence. In addition, an update requiring channel change may take precedence over an update requiring TB schedule change.

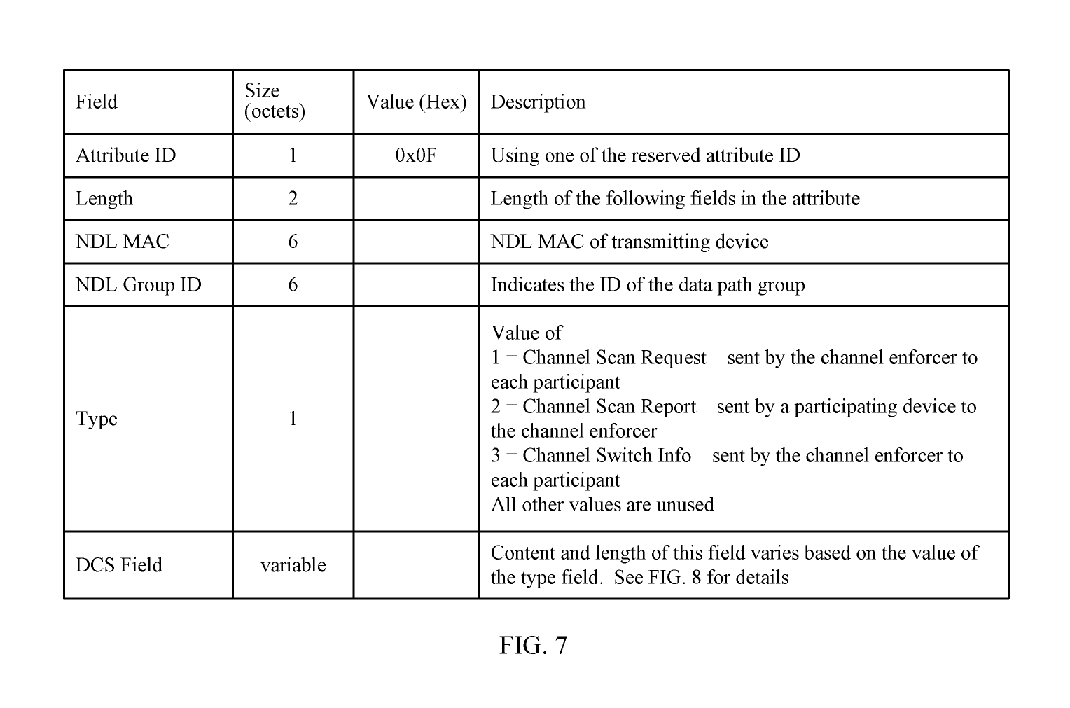

FIG. 7 illustrates an example NAN management frame (NMF) or SDF containing a Dynamic Channel Selection (DCS) attribute, according to aspects of the present disclosure. The frame of FIG. 7 may be referred to as a NMF if it is transmitted outside of a DW and may be referred to as a SDF when it is transmitted within a DW. The DCS attribute in the NMF or SDF may be used to carry information related to channel scanning, reporting, and/or switching operating channels of the NDL. According to one example, the “Type” field may indicate a Channel Scan Request transmitted by the channel enforcer to each participant, a Channel Scan Report transmitted by a participating device to the channel enforcer, or Channel Switch Information transmitted by the channel enforcer to each participant. The “DCS” field may have a variable content. Further the length of the “DCS” field may vary based on the value of the “Type” field.

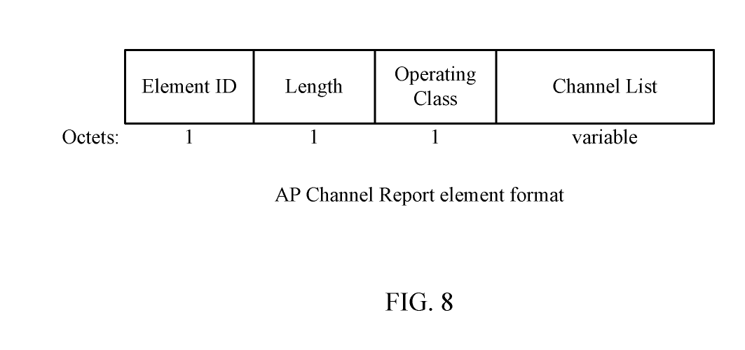

The DCS filed may convey information related to the channel scan request or channel switching. A Type=1 of the DCS field may be variable length and may include a list of channels that the owner is requesting the addressed device to scan. As shown in FIG. 8, in one system, the DCS field will carry the AP Channel Report Element (as defined in IEEE 802.11-2012) to convey a list of channels. A Type=2 of the DCS field may have a length of 5 octets. The octets may represents (1) the channel identified as the best channel from the scanned list, (2) the transmit power, (3) the RSSI on the current channel, (4) the RSSI on the adjacent channel, and (5) the current channel load. A Type=3 of the DCS filed may have a length of 2 octets. The first octet may covey the new channel to which the NDL operations will switch. The second octet may convey the channel switch interval in terms of NAN DW (e.g., as specified by a value, for example value 5).

FIG. 9 illustrates example operations 900 performed in accordance with aspects described herein. The operations may be performed by a wireless communication apparatus including the access point 110 and/or the user terminals 120. These devices may have one or more components as shown in FIGS. 2 and 3, which may be configured to perform the recited operations 900.

At 902, the apparatus may evaluate a condition of one or more channels available for use by other devices of a cluster and the apparatus. At 904, the apparatus may select one of the one or more channels as an operating channel for the cluster and the apparatus based, at least in part, on the evaluated condition. At 906, the apparatus may output an indication of the selected operating channel for transmission to the other devices of the cluster.

The devices of the cluster may belong to a group of devices that communicate with a given communication schedule, including PWs and data transmission windows. For example, the devices of the cluster may belong to a data link, such as an NDL. In this manner, the devices of the cluster may wake-up in a synchronized manner to exchange data related to a service, such as music streaming, photo sharing, sensor data, file sharing, etc. Additionally, the devices of the cluster may be a subset of a larger group of devices that wake-up in a synchronized manner, such as at a given time and on a given channel, to exchange data related to service discovery, ranging, synchronization, and data link set up. In this manner, the devices of the cluster may belong to an NDL that is part of a larger NAN group of devices. The selected operating channel may refer to an operating channel of the NDL. The operating channel of the NAN may be different from the channel on which the NDL operates.

According to aspects, after a determination is made to switch the operating channel, the apparatus may be configured to obtain usability information regarding other channels. The usability information may be obtained (e.g., by a processor via a receiver or transceiver interface) from another NAN device. The other NAN device may either be participating in the NDL or not be participating in the NDL. Additionally or alternatively, the apparatus may, itself, obtain the usability information by scanning the other channels. As described above, the determination of whether the apparatus should single-handedly perform the scan or not may depend on the number of channels to be scanned.

When the number of channels to scan exceeds a threshold value, the device may assign sets of the other channels to other devices in the NDL or other devices in the NAN for scanning. In this case, the apparatus may be configured to obtain (e.g. by a processor via a receiver or transceiver interface) the usability information from the other NDL devices.

The apparatus may obtain the usability information via a channel scanning service. The channel scanning service may be provided, for example, by a device in the NAN cluster that is not participating in the NDL. The apparatus may provide the channel scanning service with a list of the other, to-be scanned channels. Instead of providing a specific list of to-be scanned channels, the apparatus may obtain usability information for other channels. In certain scenarios, the apparatus, itself, may provide the channel scanning service. When the apparatus is configured to perform the channel scanning service, it may obtain an indication that it is selected to perform the scanning service. As described herein, an owner which provides the channel scanning service may also be evaluate the channel conditions of the current operating channel, trigger a scan of the other channels when evaluated conditions are less than a threshold, and select a new operating channel for communication via the NDL.

FIG. 10 illustrates example operations 1000 performed in accordance with aspects described herein. The operations may be performed by an apparatus for wireless communications. The apparatus may be the access point 110 and/or the user terminals 120. These apparatus may have one or more components as shown in FIGS. 2 and 3, which may be configured to perform the recited operations 1000. The apparatus may be an owner device of an NDL or a non-owner device of the NDL.

At 1002, the apparatus may switch from a current operating channel of a neighbor aware network (NAN) data link (NDL) to another operating channel of the NDL based on a channel hopping schedule. At 1004, the apparatus may communicate on the other operating channel.

The apparatus may be configured to obtain (e.g., receive) the channel hopping schedule as part of an NDL schedule. According to an aspect, and as described above, the channel hopping schedule may be based, at least in part, on at least one of a random number or a time stamp, in an effort to ensure incorporating channel diversity in every NDL schedule. Channel hopping in a NDL may advantageously be performed without an owner device, because each device in the NDL may synchronously switch to a different channel based on the NDL schedule. Accordingly, when using switching operating channels based on a hopping schedule, devices (owner and non-owner devices) may not need to assess channel conditions, hop on and off of a current operating channel to take measurements on other channel, and/or to determine a condition of a current operating channel.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface (e.g., a first interface) to output a frame for transmission. For example, a processor may output a frame, via a bus interface, to an RF front end for transmission. Similarly, rather than actually receiving or obtaining a frame, a device may have an interface (e.g., a second interface) to obtain a frame received from another device. For example, a processor may obtain (or receive) a frame, via a bus interface, from an RF front end for transmission. The second interface may include, for example, any combination of a receiver, transceiver and/or scanning module, which may be configured to both (receive signals and) perform scanning operations and also receive information related to a channel scan performed by another device. In certain scenarios, the first and second interface may be the same interface.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 900 illustrated in FIGS. 9 and 1000 illustrated in FIG. 10 correspond to means 900A illustrated in FIG. 9A and means 1000A illustrated in FIG. 10A.

For example, means for evaluating, means for selecting, means for determining, means for assigning, means for registering, means for triggering, means for switching, means for communicating, means for evaluating, means for selecting, means for outputting, means for scanning, means for jointly processing, means for providing and means for performing may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

The means receiving and means for obtaining may be a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting and means for outputting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2. The means for communicating may include a receiver, transceiver, transmitter, and/or antenna of the user terminal 120 or the access point 110 illustrated in FIG. 2.

According to certain aspects, means may be implemented by processing systems configured to perform the corresponding functions by implementing various algorithms (e.g., in hardware or by executing software instructions) described above. For example, an algorithm for evaluating a condition of one or more channels available for use by other devices of a cluster and the apparatus, selecting one of the one or more channels as an operating channel for the cluster and the apparatus based, at least in part, on the evaluated condition, and outputting an indication of the selected operating channel for transmission to the cluster.

Additionally, an algorithm for causing a wireless device in a NDL to switch from a current operating channel to another operating channel based on a channel hopping schedule and communicate on the other operating channel may be implemented by processing systems configured to perform the above functions.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Certain aspects may comprise a computer-readable medium having instructions stored (and/or encoded) thereon, the instructions being executable by one or more processors to perform the operations described herein. For example, the computer-readable medium may have instructions for evaluating a condition of one or more channels available for use by other devices of a cluster and the apparatus, selecting one of the one or more channels as an operating channel for the cluster and the apparatus based, at least in part, on the evaluated condition, and outputting an indication of the selected operating channel for transmission to the cluster. The computer-readable medium may have instructions for evaluating a condition of a current operating channel of a neighbor aware network (NAN) data link (NDL), selecting another operating channel for the NDL based, at least in part, on the evaluated condition, and to outputting for transmission an indication of the selected operating channel to other devices in the NDL.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to:
evaluate a condition of one or more channels available for use by other devices of a cluster and the apparatus, and
select one of the one or more channels as an operating channel for the cluster and the apparatus based, at least in part, on the evaluated condition; and
a first interface configured to output an indication of the selected operating channel for transmission to the other devices of the cluster.

2. The apparatus of claim 1,
wherein the processing system is configured to determine at least one of: performance of a current operating channel used by the other devices of the cluster and the apparatus, interference associated with the current operating channel, or quality of service (QoS) requirements of traffic between the other devices of the cluster and the apparatus, and
wherein the condition is evaluated based, at least in part, on the determination.

3. The apparatus of claim 1, further comprising:
a second interface configured to obtain information regarding the one or more channels from at least one of the other devices in the cluster, and
wherein the processing system is configured to evaluate the condition of the one or more channels further based on the obtained information.

4. The apparatus of claim 1, wherein:
the evaluated condition comprises at least one of the one or more channels being unusable or performance of the one or more channels being less than or equal to a threshold value.

5. The apparatus of claim 1, further comprising:
a second interface configured to obtain usability information associated with the one or more channels, and
wherein the processing system is configured to select the operating channel further based on the obtained usability information.

6. The apparatus of claim 5, wherein the processing system is configured to obtain the usability information by scanning the one or more channels.

7. The apparatus of claim 6, wherein the scanning comprises:
determining a number the one or more channels to scan is less than or equal to a threshold value.

8. The apparatus of claim 5, wherein the processing system is further configured to:
assign one or more sets of the one or more channels for scanning by the other devices in the cluster to determine the usability information,
wherein the usability information is obtained from at least one of the other devices in the cluster.

9. The apparatus of claim 8, wherein the processing system is configured to:
determine a number of the one or more channels to scan is greater than or equal to a threshold value, and
wherein the processing system is configured to assign the one or more sets of the one or more channel channels to the other devices in the cluster further based, at least in part, on the determination.

10. The apparatus of claim 5, wherein the second interface is configured to obtain the usability information via a channel scanning service.

11. The apparatus of claim 10, wherein the processing system is configured to register for the channel scanning service.

12. The apparatus of claim 11, wherein the first interface is configured to output for transmission, as part of the registration, a list of the one or more channels to be used for the channel scanning service.

13. The apparatus of claim 1, wherein the processing system provides a channel scanning service.

14. The apparatus of claim 13:
wherein the processing system is configured to generate a signal with channel usage information of the one or more channels, and
wherein the first interface is configured to output for transmission the signal, and further comprising:
a second interface configured to obtain usability information associated with the one or more channels from at least one of the other devices based, at least in part, on the signal.

15. The apparatus of claim 14, wherein the signal comprises a neighbor aware network (NAN) beacon.

16. The apparatus of claim 13,
wherein the processing system is configured to determine a condition of a current operating channel used by the other devices of the cluster and the apparatus is less than or equal to a threshold value, and further comprising:
a second interface configured to obtain an indication that the apparatus is selected to perform at least one of the scanning service or a trigger for a scan of the one or more channels when the condition of the current operating channel is less than or equal to the threshold value.

17. The apparatus of claim 5, wherein the processing system is configured to:
determine a least occupied channel of the one or more channels based on the usability information; and
select the least occupied channel as the operating channel for the cluster.

18. The apparatus of claim 1,
wherein the processing system is further configured to generate an indication of a time period for when to switch to the selected operating channel,
wherein the first interface is further configured to output the indication for transmission.

19. The apparatus of claim 18, wherein the indication of the time period corresponds to a discovery window (DW) time.

20. The apparatus of claim 1, wherein the first interface is configured to output for transmission the indication of the selected operating channel via a broadcast message to the other devices in the cluster, a unicast message to each of the other devices in the cluster, or an advertisement message in a neighbor aware network (NAN) associated with the cluster.

21. The apparatus of claim 1, wherein the processing system is configured to select the operating channel further based, at least in part, on a channel hopping schedule.

22. The apparatus of claim 21, wherein the first interface is configured to output for transmission the channel hopping schedule in a neighbor aware network (NAN) data link (NDL) schedule.

23. The apparatus of claim 1, wherein the other devices of the cluster and the apparatus comprise a subset of a group of devices that wake-up in a synchronized manner to exchange data.

24. The apparatus of claim 1, wherein the processing system is configured to:
determine a channel occupancy of a current operating channel used by the other devices of the cluster and the apparatus is greater than or equal to a threshold value; and
in response to the determination, perform a channel scan to obtain information regarding the one or more channels,
wherein the evaluation is based, at least in part, on the obtained information.

25. The apparatus of claim 1, wherein the processing system is configured to:
determine a channel occupancy of a current operating channel used by other devices of the cluster and the apparatus is greater than or equal to a threshold value;
in response to the determination, output, via the first interface, a request for information associated with the one or more channels; and
obtain, via a second interface, results of a scan from one or more other devices in the cluster,
wherein the evaluation is based, at least in part, on the obtained results.

26. An apparatus for wireless communications, comprising:
a processing system configured to switch from a current operating channel of a neighbor aware network (NAN) data link (NDL) to another operating channel of the NDL based on a channel hopping schedule; and
an interface configured to communicate on the other operating channel.

27. The apparatus of claim 26, wherein the interface is configured to obtain the channel hopping schedule as part of an NDL schedule.

28. The apparatus of claim 26, wherein the channel hopping schedule is based, at least in part, on at least one of a random number or a time stamp.

29.-86. (canceled)

87. A station for wireless communications, comprising:
a processing system configured to:
evaluate a condition of one or more channels available for use by other devices of a cluster and the apparatus; and
select one of the one or more channels as an operating channel for the cluster and the apparatus based, at least in part, on the evaluated condition; and
a transmitter configured to output an indication of the selected operating channel for transmission to the other devices of the cluster.

88. (canceled)
